(19) United States
(12) Patent Application Publication
(10) Pub. No.: US 2005/0154685 A1
(43) Pub. Date: Jul. 14, 2005

(54) Methods and systems providing the capability to track intra-organizational packages

(75) Inventors: Steve Mundy, El Dorodo Hills, CA (US); Gary Wright, Manteca, CA (US)

Correspondence Address: ALSTON & BIRD LLP;BANK OF AMERICA PLAZA, 101 SOUTH TRYON STREET, SUITE 4000, CHARLOTTE, NC, 28280-4000, US

(73) Assignee: United Parcel Service of America, Inc., Atlanta, GA (US)

(21) Appl. No.: 10/755,193

(22) Filed: Jan. 8, 2004

(51) Int. Cl. G06F 17/60

(52) U.S. Cl. 705/404; 705/401

(57) ABSTRACT

Methods and systems disclosed herein are used to track packages sent via an intra-organizational mail system, even when such mail system includes shipping some packages in bulk to remote organizational locations via an external carrier. A package administration system generates package identifiers to be associated with packages. In the event that such packages are aggregated with other packages destined for a common location, the package identifiers are associated with a tracking identifier identifying the consolidated master package containing a plurality of such packages. The methods and systems also offer the capability to sort packages based on common delivery locations.

### BACKGROUND OF THE INVENTION

1. Field of the Invention

The present invention generally relates to tracking the movement of packages as they are transported both internally within an organization, and as they are shipped externally by a carrier on behalf of the organization. The invention also relates to providing notifications to interested parties as to the status of packages during transport.

2. Description of the Related Art

Within an organization, there is typically a significant amount of internal mail transferred between different office locations. Many organizations have a mail room at each office location or business center, that acts as the central receiving point for mail, parcels, and other such items. These items will broadly be referred to as either ‘mail’ or ‘packages.’ The mail or packages are either received from workers within the office location to be sent out from such location (i.e., “outbound packages”), or can be received from an external carrier or other source for distribution to workers at the office location served by the mailroom (i.e., “inbound packages”). Many enterprises include a number of locations which are geographically remote from one another. In such organizations, it is commonplace for packages to be internally routed between workers within the same organization, but who are located at respective office locations that are geographically remote from one another.

Accordingly, such packages are effectively sent internally within the organization, although the services of an external carrier such as UPS®, Inc. may be used to transport the packages between locations. Some organizations have their own internal mail service to route mail or packages between different office locations, although this is relatively uncommon, particularly in cases in which the packages are shipped between offices that are geographically remote. In many enterprises, for local mail and packages, internal mail is sent using generic envelopes with handwritten “Send To” information. As a cost effective way of transferring mail between different organizational locations, some organizations ship packages destined for a common location in bulk via the services of an external carrier, such as UPS®, Inc.

A problem with these and other such internal mail systems is that they provide little or no “visibility” (i.e., tracking data) as to where an individual package is, or has been, during transport. This lack of visibility forces employees to choose between sending their package via the more economical internal mail system, which provides no information regarding a package's status, and sending the package by some other means, such as an external carrier, which can at least provide tracking data on the package as it travels from one location to another. As a result, employees often rely on overnight mail service to send their important internal documents. Unfortunately, this can be a relatively expensive solution in comparison to using the internal mail system, and it still does not provide the “desk-to-desk” visibility that would help avoid packages being lost or misplaced internally. It also provides limited or no ability for interested persons to be able to determine the status of a package, which may be desirable for various reasons. For example, the ability to determine that status of a package during transportation may be important to providing the ability to plan work schedules that are dependent upon arrival of the contents of the package or mail.

Such visibility may also provide an “audit trail” for establishing the whereabouts of a package during shipment. This may be important to determining where a package that has been delayed or lost is in the shipment process, which may be particularly important if the package contents are time-sensitive or subject to spoilage. The ability to track the mail or package can also be important from the standpoint of verifying that the package was in fact sent, which may be important in legal contexts such as for the purposes of providing notification of legal rights, or acceptance of or performance under a contract, for example. In addition, the ability to track a package or mail item provides a degree of oversight and accountability for those involved in the package or mail shipping process, because, in the event a package is lost, tracking ability provides insight into possible system or human errors leading to loss of the package. For at least these reasons, it would be desirable in many contexts to provide the ability to better track packages sent between office locations of an organization.

A solution is therefore needed to provide desk-to-desk tracking visibility for packages sent using an internal mail system, even when part of the internal mail system may include shipping such packages in bulk via an external carrier.

### BRIEF SUMMARY OF THE INVENTION

The present invention is directed to a system for, and methods of, shipping intra-organizational mail in a relatively cost efficient manner, so that such mail can be tracked at the individual package level even though they are transported in bulk between organizational locations via an external carrier. Optionally, in addition to providing the ability to track packages shipped in bulk between office locations, the ability to track packages can be extended to include tracking of packages within the office locations. Generally described, the invention allows package senders to associate package identifiers with their respective packages, which can then be associated with a tracking identifier associated with a master package containing the packages shipped in bulk via an external carrier from one organizational location to another.

In one embodiment, a method of providing the capability to track intra-organizational mail comprises receiving packages with respective package identifiers at a sender mail room; aggregating packages that have a common delivery location so that the packages can be shipped to the delivery location in a consolidated master package; scanning the package identifiers of the packages being placed into the master package using a sender mail room computer; transmitting the scanned package identifiers of the packages contained within the master package from the sender mail room computer to the package administration system; receiving a tracking identifier from the package administration system for the master package at the sender mail room computer; associating the tracking identifier with the master package; and shipping the master package with the associated tracking identifier to the delivery location. The method can comprise using a computer to sort the packages based on common delivery locations, which can be determined using the retrieved recipient address data associated with the scanned package identifiers. The method can also comprise weighing the master package for use in billing the organization for shipment of the master package from the sender mail room to the delivery mail room.

In another embodiment of a disclosed method, the package administration system can receive recipient address data for a corresponding package from a sender, generate a package identifier, store the package identifier in association with the recipient address data, and transmit the package identifier to the sender. In this method, the package administration system receives package identifiers from a sender mail room computer terminal for a plurality of packages contained in a master package destined for a common delivery location, generates a tracking identifier for identifying the master package containing the plurality of packages, stores the tracking identifier in association with the package identifiers, and transmits the tracking identifier to the sender mail room.

The above-described method can comprise generating departure tracking data including the approximate time of departure of the master package from the sender mail room, which can be recorded in association with the tracking identifier. Similarly, arrival tracking data can be generated to mark the arrival of the master package at the delivery mail room location. If the master package is transported via an external carrier, tracking data can be generated and stored in association with the tracking identifier indicating the status of the master package in transport from the sender mail room to the delivery mail room location.

In another embodiment, the system for providing the capability to track packages comprises a computer terminal capable of communicating with a package administration system and a scanning device operatively coupled to communicate with the computer terminal, which is capable of scanning package identifiers associated with packages and communicating them to the computer. The computer terminal can execute a shipping application, which is operable by the user to retrieve a tracking identifier from the package administration system and associate the tracking identifier with the scanned package identifiers for the packages having a common delivery location to be contained within a master package. Additionally, the system comprises a printer for printing a shipping label with the tracking identifier for association with the master package.

In a preferred embodiment, the invention comprises a master package capable of containing a plurality of packages destined for the same delivery location. The packages have respective package identifiers associated therewith, and a tracking identifier associated with the master package.

In a preferred embodiment, the invention comprises a package administration system having a server capable of communicating with at least one client running a shipping application, and a data storage unit having a database for storing package identifiers of a plurality of packages destined for a common delivery location, in association with a tracking identifier identifying a master package containing the packages.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a block diagram of a system for tracking packages sent from a sender location to a delivery location in an aggregated master package in accordance with a preferred embodiment of the invention.

FIG. 2 is a block diagram of a package administration system for tracking packages in accordance with a preferred embodiment of the invention.

FIG. 3 is a flowchart of a general method for tracking packages using the package administration system in accordance with a preferred embodiment of the invention.

FIGS. 4-10 are flowcharts of a general method for tracking an intra-organizational package in accordance with a preferred embodiment of the invention.

FIGS. 11-14 are flowcharts of general methods for using communications such as emails to notify interested persons of tracking events in accordance with a preferred embodiment of the invention.

FIG. 15 is a block diagram of a mail room computer used to sort packages bound for a common destination in accordance with a preferred embodiment of the invention.

FIGS. 16-17 are flowcharts of a general method for sorting packages in a sender mail room based on common delivery locations in accordance with a preferred embodiment of the invention.

FIG. 18 is a typical screen snapshot of a client shipping application used by the sender of a package to generate a package label including a package identifier in accordance with a preferred embodiment of the invention.

FIG. 19 is a typical example of a printed package label including a package identifier to be associated with a package in accordance with a preferred embodiment of the invention.

FIG. 20 is a typical example of a shipping label including a tracking identifier to be associated with a master package in accordance with a preferred embodiment of the invention.

### DETAILED DESCRIPTION OF THE INVENTION

The present invention now will be described more fully hereinafter with reference to the accompanying drawings, in which some, but not all embodiments of the invention are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

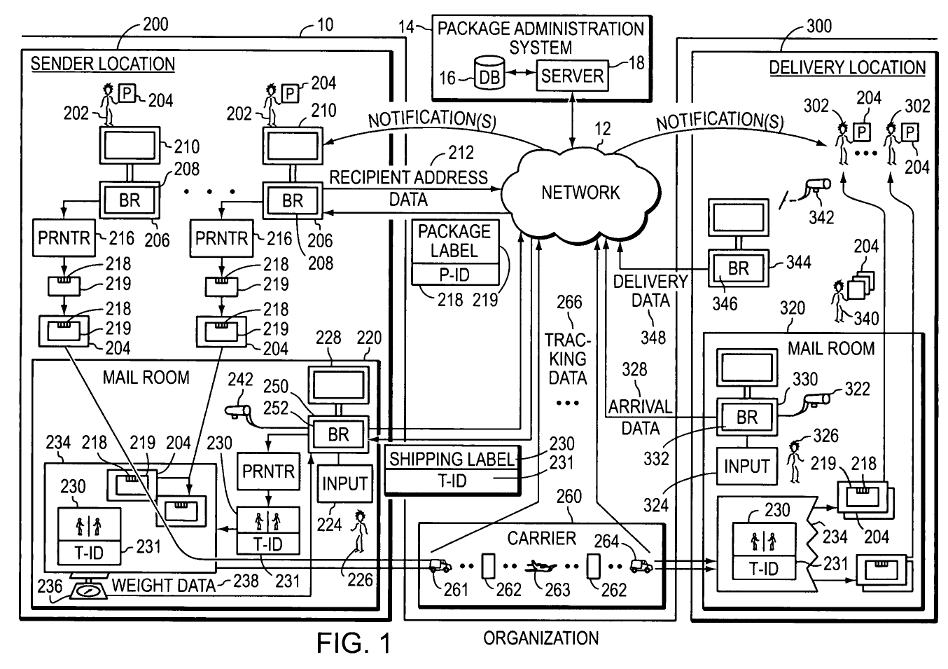

FIG. 1 is a block diagram of an embodiment of the current invention. Organization 10 has a plurality of different locations, as is typical of many enterprises. In the embodiment of FIG. 1, organization 10 includes a sender location 200 and a delivery location 300. At the sender location 200, at least one sender 202 carries out a process for sending an intra-organizational package 204 to a corresponding recipient 302 located in delivery location 300. The sender location 200 has at least one sender computer terminal 206. The computer terminal 206 can be connected to communicate with a package administration system 14 over a network 12. The network 12 can be the Internet or other public communication network, for example.

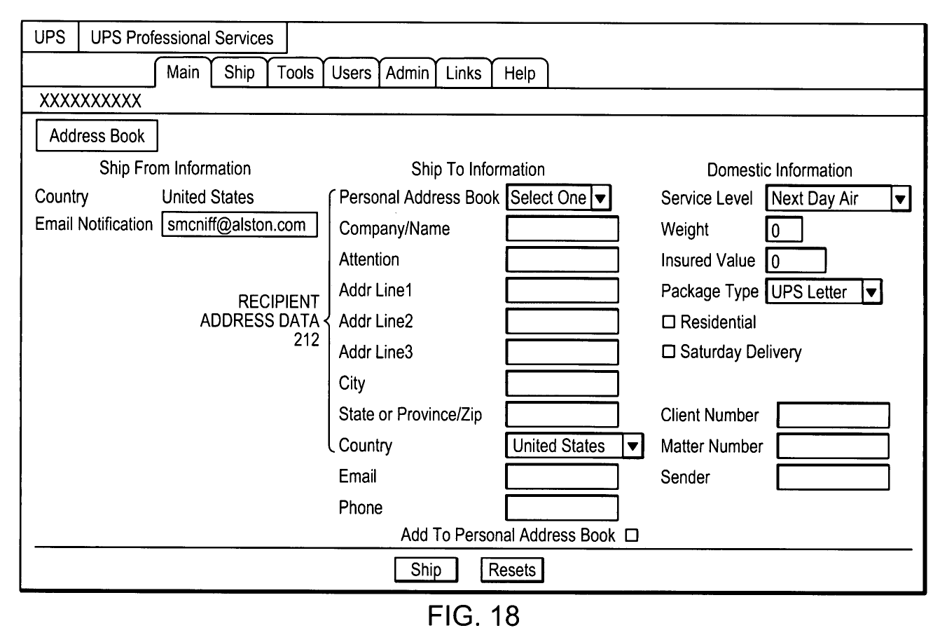

Running on the sender computer 206 is a web browser application 208, that allows a sender 202 to access the package administration system 14 over the network 12. Using the browser 208, the sender 202 can enter or select recipient address data 212 corresponding to a destination for respective package 204. Optionally, the sender 202 can enter data indicating the recipient's name, email address, telephone number, carrier account data, and package-related data such as weight, service level, insured value, and package type, for example. Jumping briefly to FIG. 18, a computer screen snapshot is shown, illustrating how, in one embodiment, a typical visual interface screen would appear to a sender 202 accessing the package administration system 14 using the browser 208, and viewing the results on a monitor 210 connected to receive output from the computer 206, for example. Returning to FIG. 1, The sender 202 can operate the sender computer 206, causing it to transmit recipient address data 212, and optionally other entered data, to the package administration system 14 over the network 12.

The package administration system 14 has the capability to generate a package identifier 218 for unique identification of the package 204. The package administration system 14 associates the package identifier 218 with the received recipient address data 212, and stores the information in a package administration system database 16. In a preferred embodiment, the package administration system 14 transmits a package label 219 with the package identifier 218 to the sender computer 206 via the network 12. However, one of ordinary skill in the art will readily recognize that the present invention does not require that the package identifier 218 be sent with the package label 219. In other words, the package identifier 218 could be sent from the package administration system 14 to the sender computer 206 alone, or in conjunction with yet other information besides the package label 219. In the preferred embodiment, the sender computer 206 receives the package label 219 with package identifier 218, and is connected to provide such data to the printer 216. The printer 216 receives the package label 219 including the package identifier 218 and other optional indicia from the sender computer 206, and produces such package label 219 on print media. For example, the package label 219 can be printed as ink or the like, and the print media can be paper, a pressure-sensitive adhesive label, etc., to which the printer fixes the package identifier, and other optional indicia. The sender 202 physically associates the printed package label 219 with package identifier 218 on the package 204, such as by affixing it with tape, adhesive, or otherwise applying it to the package 204. The sender 202 transports the package 204 with the associated package label 219 having package identifier 218 to a sender mail room 220.

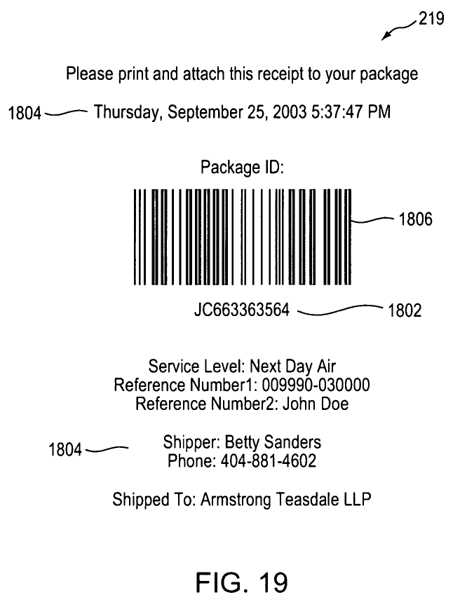

Jumping briefly to FIG. 19, a typical example of a package label 219 used in one embodiment of the present invention is shown. In this embodiment, package label 219 includes a human-readable version of a package identifier 1802, and other optional human-readable indicia 1804, such as date, time, service level, etc. The package label 219 shown in FIG. 19 also includes optical indicia in the form of a bar code 1806 capable of comprising at least the package identifier 218, and optionally other indicia. In another embodiment, the package label 219 can include electromagnetic media such as an RFID tag capable of storing a package identifier 218 and other optional indicia, for example.

Returning to FIG. 1, by using the recipient address data 212 associated with the package identifiers 218, a mail room attendant 226 aggregates the packages 204 received in the sender mail room 220 according to the package destination. This occurs so that all aggregated packages 204 having, for example, a common delivery location 300 can be shipped to the common delivery location within a consolidated master package 234. The sorting of packages 204 bound for a common destination can be carried out by hand, or can be computer-assisted. The packages 204 can be aggregated and shipped in a master package 234 on a regular basis, such as once each workday or once per work shift, for example. To facilitate this process, the mail room attendant uses a web browser 252 running on a sender mail room computer 250, which is coupled to communicate with the package administration system 14 via the network 12.

As the mail room attendant 226 places aggregated packages 204 destined for common delivery location 300 in the master package 234, the mail room attendant causes the package identifiers 218 of respective packages to be input to the sender mail room computer 250. In a preferred embodiment, the respective package identifiers 218 are scanned into sender mail room computer 250 using a scanning device 222, which is coupled to communicate with such computer. The scanning device 222 can include an optical reader capable of reading one- or two-dimensional optical indicia such as bar code labels, or it may include a device operable with electromagnetic media such as Radio Frequency Identification (RFID) tags. Alternatively, a mail room attendant 226 can simply use eyesight to read and enter the package identifiers 218 into the sender mail room computer 250 using an input device 224. This input device can be a keyboard, keypad, or other device.

Additionally, after all of the packages 204 having common delivery location 300 are placed in the master package 234, the master package can be placed on a scale 236, to generate weight data 238. The scale 236 can be coupled to communicate the weight data 238 to the sender mail room computer 250. The sender mail room computer 250 receives the weight data 238, and can be connected to communicate such data to the package administration system 14 for use in billing the organization 10 for shipment of the master package 234 from the sender location 200 to the delivery location 300.

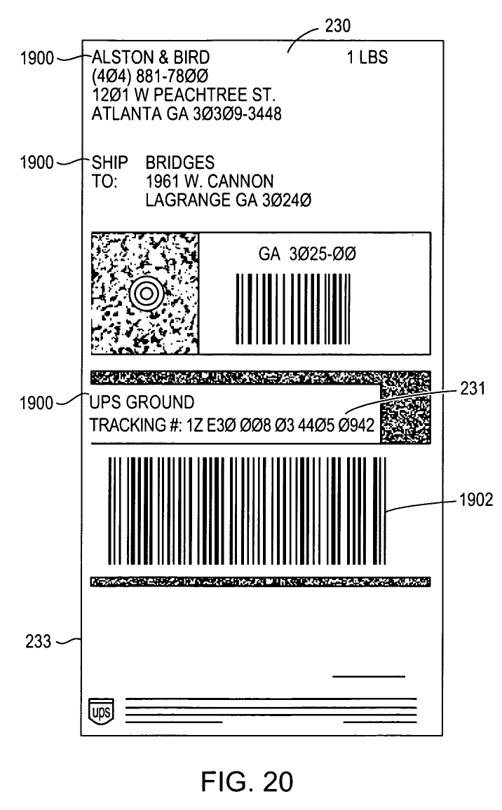

The attendant 226 and/or sender mail room computer 250 generates a request for a shipping label 230 with a tracking identifier 231. The request can include the package identifiers 218 for the packages to be included in the master package 234. The request for the shipping label 230 with tracking identifier 231 is transmitted from the computer 250 to the package administration system 14 via the network 12. The package administration system 14 receives the request and optional package identifiers 218, generates a shipping label 230 including a tracking identifier 231, optionally stores the package identifiers 218 in association with the tracking identifier 231, and transmits the shipping label with tracking identifier to the computer 250. The computer 250 receives the shipping label 230 with tracking identifier 231, and is operatively coupled to provide such shipping label with tracking identifier to the printer 232, which prints such shipping label with tracking identifier on print media 233. The print media 233 can be paper, a pressure-sensitive adhesive label, or other such media. For example, jumping briefly to FIG. 20, an embodiment of a typical shipping label 230 in accordance with the present invention is shown. In the embodiment of FIG. 20, the shipping label 230 is printed on an adhesive-backed label 233, and includes various human-readable indicia 1900, a human readable version of a tracking identifier 231, and a bar code 1902 capable of storing at least the tracking identifier 231 in an optical format. Returning to FIG. 1, a mail room attendant 226 physically associates the media 233 bearing the printed shipping label 230 with tracking identifier 231 with the master package 234, such as by attaching it with tape, or if in the form of an adhesive-backed label, applying such label to the package, etc. The mail room attendant 226 ships the master package 234 to the delivery location 300.

The master package 234 can be shipped via an external carrier 260. Additionally, although not required to implement the current invention, the package administration system 14 can be operated by the external carrier 260. As the carrier 260 transports the master package 234 from the sender location 200 to the delivery location 300, optical or electromagnetic scanners and computers internal to the carrier's logistics network scan the tracking identifier 231 on the master package 234, to generate tracking data 266 indicating the status of the master package during transport. For example, the tracking identifier 231 of the master package 234 can be scanned by such equipment at one or more of a number of different points, such as by a driver 261 who picks up the master package at the sender mail room 220 and uses a hand-held scanning device to read the tracking identifier 231 from the master package 234, at hubs 262 that receive and sort the package and have equipment to scan the tracking identifier 231, and finally by the delivery driver 264 who delivers the package to the delivery mail room 320 and uses a hand-held device to scan the tracking identifier 231 to generate tracking data 266 prior to delivery to the recipient 302.

The tracking data 266 can include data identifying the date, time, and/or place of particular events associated with the master package 234 as it is transported from the sender mail room 220 to the delivery mail room 320 within the carrier's logistics network. Such events can include the arrival or departure of the master package 234 at or from particular locations within the logistics network of the carrier 260 as the master package is transported. Such tracking data 266 can also include the identity of persons handling the package, such as the pickup or delivery driver, or a person acknowledging receipt of the package at a particular location by signing for the master package. The package administration system 14 can provide access to the tracking data 266 related to the master package 234 via the network 12, so that a sender 202, a recipient 302, and potentially others can determine the status of a package 204 during transportation, both inside and outside of the logistics network of the carrier 260.

The delivery location 300 has a delivery mail room 320, which includes delivery mail room computer 330 connected to communicate with the package administration system 14 via the network 12. Also provided in the sender mail room 320 is an optical or electromagnetic scanning device 322 connected to communicate with the delivery mail room computer 330. The master package 234 arrives at the delivery mail room 320, and a mail room attendant 326 scans the tracking identifier 231 using the scanning device 322 to generate arrival tracking data 328. After the master package 234 is opened, and the packages 204 contained therein are removed, the scanning device 322 and delivery mail room computer 330 can generate additional arrival tracking data 328 by scanning package identifiers 218 associated with respective packages 204. For example, the scanning of the package identifiers 218 of packages 204 within the master package 234 can be performed to provide a record of the packages received at the delivery location, or it may be done to verify that the packages 204 indicated as being in the master package 234 were in fact present at the delivery location 300. Using a web browser application 332 running on the delivery mail room computer 330, arrival tracking data 328 comprising the tracking identifier 231, and optionally also the package identifiers 218, can be received by the computer, and transmitted to the package administration system 14 over the network 12.

Subsequent to the arrival processing described above, delivery personnel 340 take the packages 204 from the delivery mail room 320 and deliver them to corresponding recipients 302. Optionally, delivery tracking data 348, including approximate dates, times, places, and/or personnel involved in delivery of packages 204 at respective recipient locations, can be generated. In one embodiment, a portable scanning device 342 is used to generate delivery tracking data 348 by scanning the package identifier 218. This scanning device 342 may be wireless or otherwise coupled to communicate its data to the package administration system 14, whether directly or by an intermediate computer, such as units 330 or 344. In another embodiment, delivery personnel 340 simply make note of delivery tracking data. The delivery personnel 340 can accomplish this task by writing delivery tracking data 348 on a notepad, using an electronic data capture device (e.g., a personal digital assistant), or by preparing some other form of record, etc. for respective packages 204. Using a delivery location computer 344 executing a browser application 346, the delivery tracking data 348 can be input to computer 344 and transmitted to the package administration system 14 via the network 12. The package administration system 14 can store the delivery tracking data 348 in correspondence with the tracking identifier 231 to permit the sender and/or recipient to determine the status of a package 204.

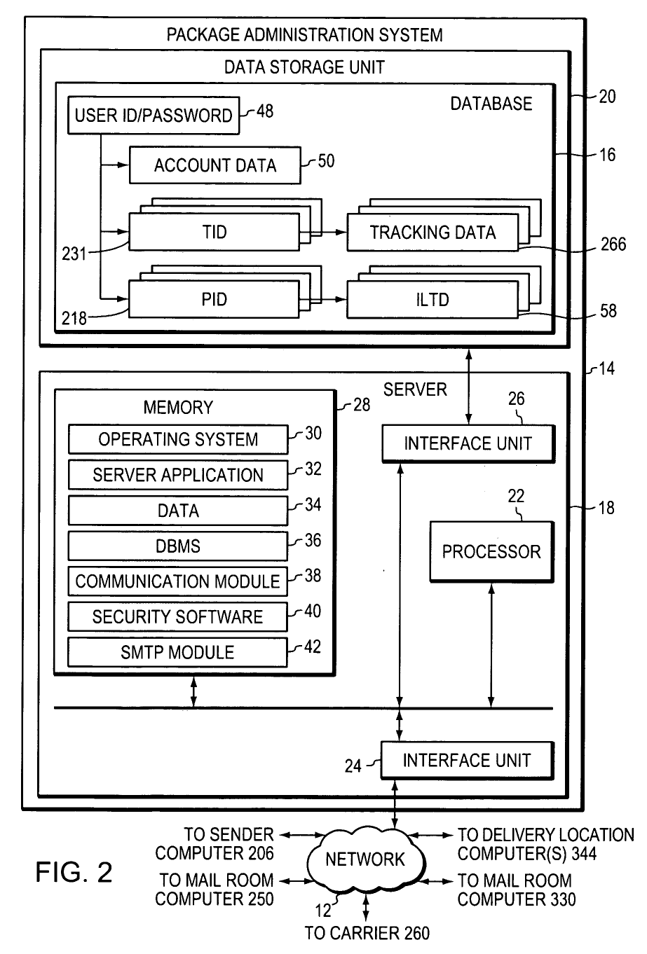

FIG. 2 shows a block diagram of a package administration system 14 in accordance with the invention depicted in FIG. 1. The package administration system 14 includes a server 18 having a processor 22, a first interface unit 24, a second interface unit 26, and memory 28. The memory 28 comprises a plurality of software applications executed by the processor 22 including an operating system 30 for controlling the allocation and usage of hardware resources, and a server application 32 for handling the server-side functionality of the package administration system. The memory 28 also includes a generic data storage area 34. Data storage area 34 can be used to provide temporary storage space needed for data required by the modules and applications executed by the server 18, for example. The memory 28 further comprises a database management system (DBMS) 36 for handling actions taken with respect to the package administration system database 16; a communication module 38 for handling communications to and from the server; security software 40 for performing user authentication and other security type services; and a simple mail transfer protocol (SMTP) module 42 to be used in one embodiment of the invention when sending and/or receiving email notifications over a network 12. The server 18 uses the first interface unit 24 to send and receive data over a network 12, while the second interface unit 26 is used to transfer data between the server 18 and a data storage unit 20, which also comprises part of the package administration system 14.

The data storage unit 20 includes a database 16. In one embodiment, the database 16 contains records of related data fields including user identification (ID) and password 48, and account data 50 associated with the user ID and password. If there is one or more master packages 234 associated with the user account, the database 16 can also contain a tracking identifier (TID) 231 associated with each such master package, as well as any tracking data 266 associated with the master package. The tracking data 266 can include data identifying the date, time, and/or place of particular events associated with the master package 234 as it is transported from a sender mail room 220 to a delivery mail room 320 within a carrier's logistics network. Such events can include the arrival or departure of the master package 234 at or from particular locations within the logistics network of the carrier 260 as the master package is transported. Such tracking data 266 can also include the identity of persons handling the package, such as the pickup or delivery driver, or a person acknowledging receipt of the package at a particular location by signing for the master package.

The database 16 can further comprise one or more package identifiers (PID) 218 associated with respective packages 204. Each package identifier 218 can optionally have intra-organizational location tracking data (ILTD) 58 associated with it. The ILTD 58 can include, for example, delivery tracking data 348 such as approximate dates, times, places, and/or personnel involved in delivery of packages 204 at respective recipient locations 302. When a package 204 associated with the user account is shipped in a master package 234, from a sender location 200 to a delivery location 300, the ILTD 58 can optionally include a pointer or a link to the tracking identifier 231 of the master package in which the package 204 was placed for shipment. In this way, visibility for such a package 204 includes both the ILTD 58 and the tracking data 266 as the package 204 travels from a sender 202 to a recipient 302.

Those skilled in the art will recognize that the functionality of the package administration system 14 as described in FIG. 2 may be carried out on a plurality of computers capable of communicating via a network such as the internet or other communication network, and, accordingly, need not be discussed here for an understanding of the subject invention. In other words, rather than have a single server 18 to perform the described functions, these functions can be executed by two or more distributed computers, and such modification is expressly contemplated to be within the scope of this invention.

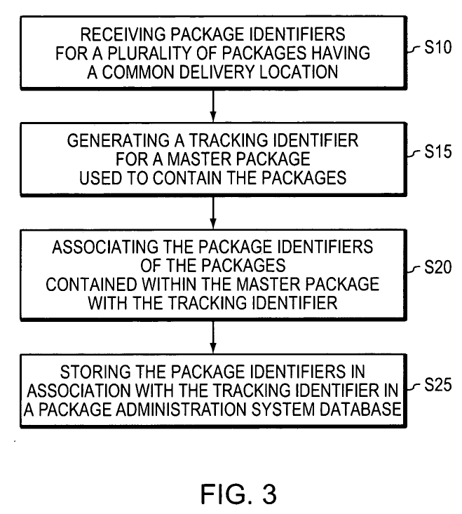

FIG. 3 shows a process that can be performed by the package administration system 14, or more specifically, the server 18 in combination with the database 16, in accordance with the present invention. At step S10, package identifiers 218 for a plurality of packages 204 having a common delivery location 300 are received. At step S15, a tracking identifier 231 is generated for a master package 234 used to contain the plurality of packages 204. At step S20, the package-identifiers 218 of the packages 204 contained within the master package 234 are associated with the tracking identifier 231. At step S25, the package identifiers 218 in association with the tracking identifier 231 are stored in a package administration system database 16.

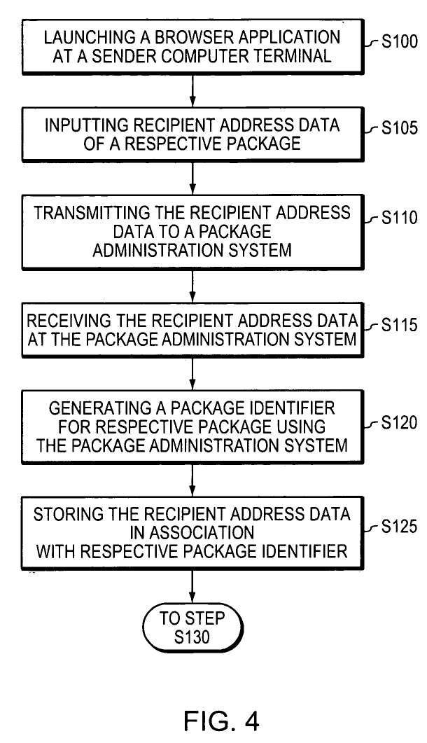

FIG. 4 shows a typical sequence of steps for tracking an intra-organizational package 204 in accordance with the system schematically depicted in FIG. 1. At step S100, a browser application 208 is launched at a sender computer terminal 206. At step S105, a sender 202 inputs recipient address data 212 for a package 204 that needs to be mailed to a recipient 302. At step S110, the recipient address data 212 is transmitted to a package administration system 14. At step S115, the recipient address data 212 is received at the package administration system 14. At step S120, the package administration system 14 generates a package identifier 218 for respective package 204. At step S125, the package administration system 14 stores the recipient address data 212 in association with the respective package identifier 218.

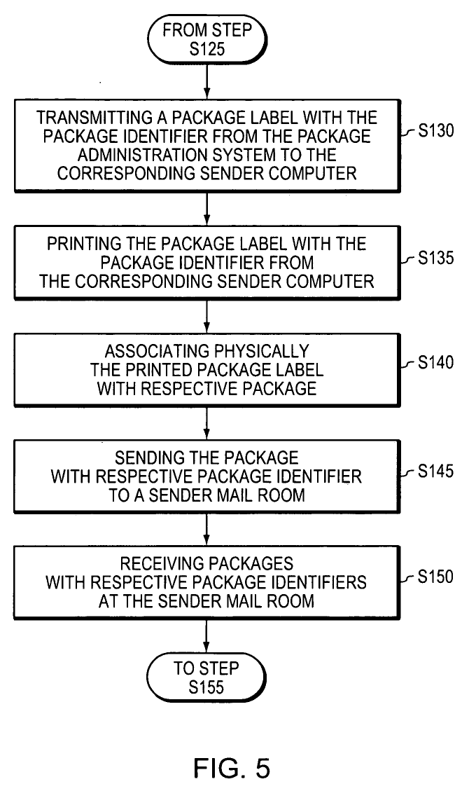

Turning now to FIG. 5, the process continues at step S130, wherein the package administration system 14 transmits a package label 219 with the package identifier 218 to the corresponding sender computer 206. At step S135, the package label 219 with the package identifier 218 is printed on print media from a printer 216 connected to the sender computer 206. At step S140, a sender 202 physically associates the printed package label 219 bearing the package identifier 218 with respective package 204. At step S145, the package 204 is sent with respective package identifier 218 to a sender mail room 220. At step S150, packages 204 with respective package identifiers 218 are received at the sender mail room 220.

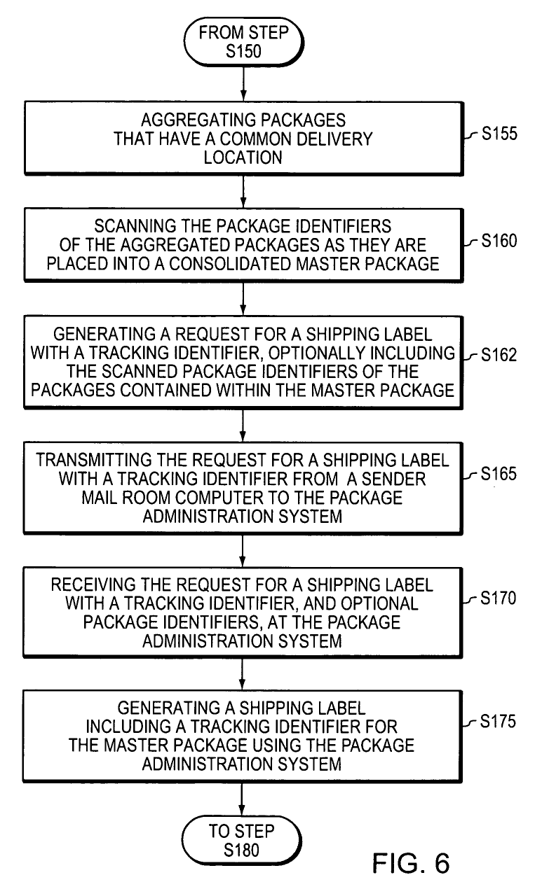

Turning now to FIG. 6, the process continues at step S155, wherein a mail room attendant 226 aggregates the packages 204 that have a common delivery location 300. The sorting of the packages 204 bound for a common destination can be carried out by hand or can be computer assisted. At step S160, a mail room attendant 226 scans the package identifiers 218 of the aggregated packages 204 as they are placed into a consolidated master package 234 destined for the common delivery location 300. At step S162, the attendant 226 generates a request for a shipping label 230 with a tracking identifier 231. The request can optionally include the package identifiers 218 for the packages 204 included in the master package 234. At step S165, the request for a shipping label 230 with a tracking identifier 231 is transmitted from the sender mail room computer 250 to the package administration system 14. At step S170, the request for a shipping label 230, optionally including the package identifiers 218, is received at the package administration system 14. At step S175, the package administration system 14 generates a shipping label 230 including a tracking identifier 231 for the master package 234.

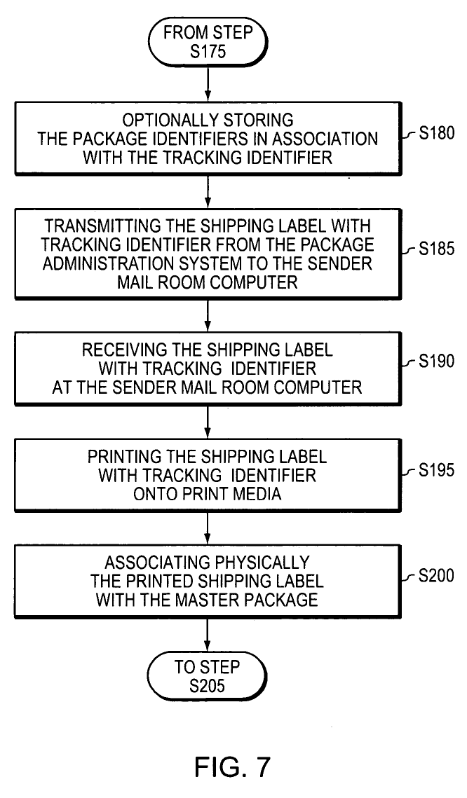

Turning now to FIG. 7, the process continues at step S180, wherein the package administration system 14 optionally stores the package identifiers 218 in association with the tracking identifier 231. At step S185, the package administration system 14 transmits the shipping label 230 with tracking identifier 231 from the package administration system to the sender mail room computer 250. At step S190, the computer 250 receives the shipping label 230 with tracking identifier 231 from the package administration system 14. At step S195, the shipping label 230 with tracking identifier 231 is printed from the printer 232 connected to the computer 250. At step S200, a mail room attendant 226 physically associates the printed shipping label 230 with the master package 234.

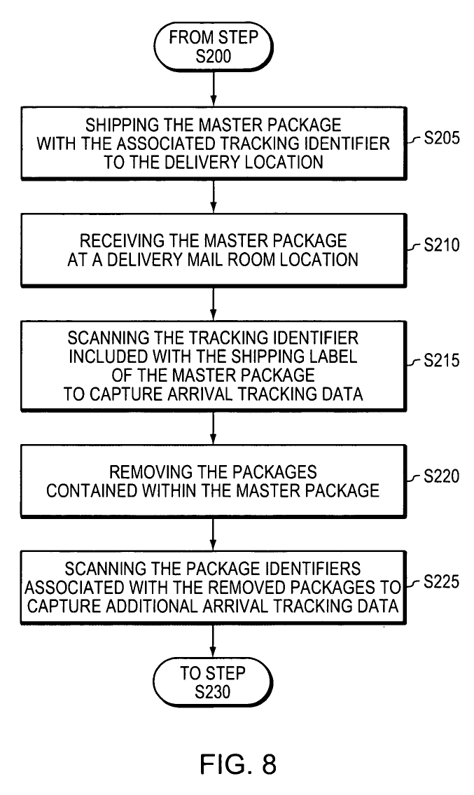

Turning now to FIG. 8, the process continues at step S205, wherein the mail room attendant 226 ships the master package 234 with the associated tracking identifier 231 to the common delivery location 300. The master package 234 can be shipped via a carrier 260, which generates tracking data 266 indicating the status of the master package during transport, and transmits such tracking data to the package administration system 14. At step S210, the master package 234 is received at the delivery mail room 320. At step S215, a mail room attendant 326 scans the tracking identifier 231 of the master package 234 to capture arrival tracking data 328. At step S220, a mail room attendant 326 removes the packages 204 from the master package 234. At step S225, the mail room attendant 326 scans the package identifiers 218 associated with the removed packages 204 to capture additional arrival tracking data 328.

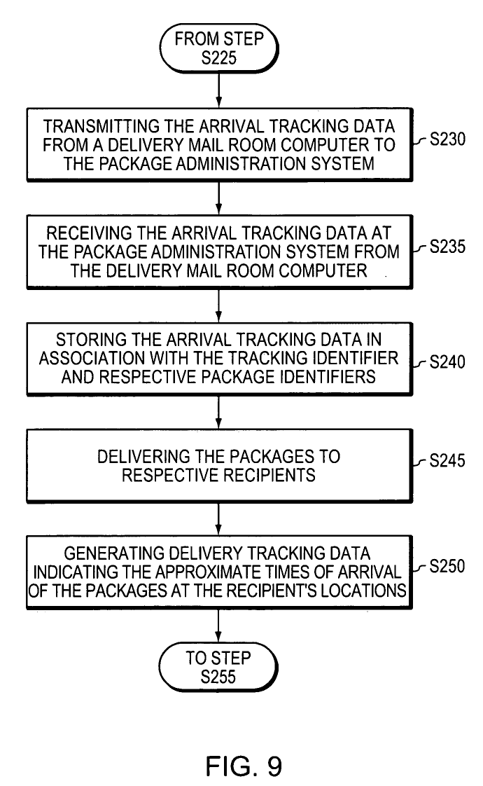

Turning now to FIG. 9, the process continues at step S230, wherein the arrival tracking data 328 is transmitted from the delivery mail room computer 330 to the package administration system 14. At step S235, the arrival tracking data 328 is received at the package administration system 14. At step S240, the package administration system 14 stores the arrival tracking data 328 in association with the tracking identifier 231 and respective package identifiers 218. At step S245, delivery personnel 340 deliver the packages 204 to respective recipients 302. At step S250, the delivery personnel 340 generate delivery tracking data 348, which can include approximate dates, times, places, and/or personnel involved in delivery of packages 204 at respective recipient locations.

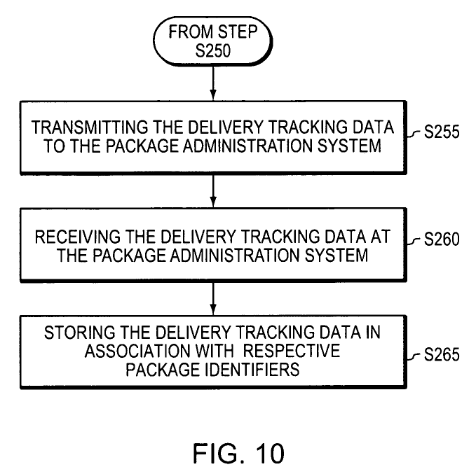

Turning now to FIG. 10, the process continues at step S255, wherein the delivery tracking data 348 is transmitted from a delivery location computer 344 to the package administration system 14. At step S260, the delivery tracking data 348 is received at the package administration system 14. At step S275, the package administration system 14 stores the delivery tracking data 348 in association with the respective package identifiers 218.

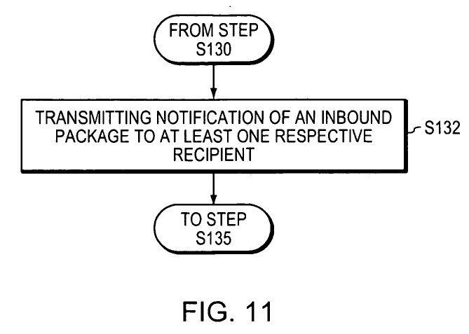

FIGS. 11-14 illustrate how notification steps can optionally be included in the process described above. FIG. 11 shows a process, wherein at step S132, a communication such as an email notification is sent to at least one recipient 302 informing them of an inbound package 204. This step can be performed by the package administration system 14 after it generates a package identifier 218 for the package 204 that is to be shipped by the corresponding sender 202. However, this does not exclude the possibility that this step can be performed at another time at which its performance may be logical.

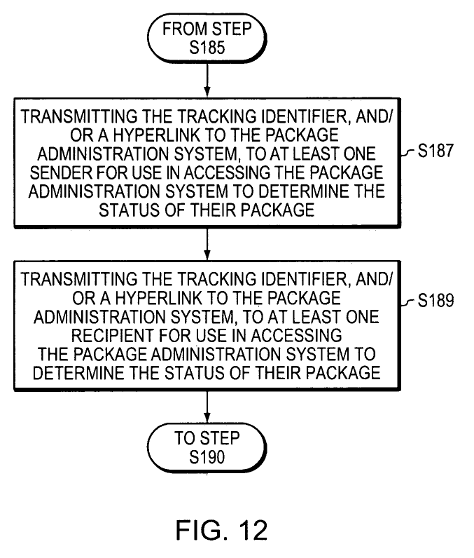

FIG. 12 shows a process wherein at step S187 a communication such as an email containing a tracking identifier 231, associated with a master package 234, is transmitted to at least one sender 202 for use in accessing the package administration system 14 to determine the status of a package 204 contained within the master package. Similarly, at step S189, a communication such as an email containing a tracking identifier 231, associated with a master package 234, is transmitted to at least one recipient 302 for use in accessing the package administration system 14 to determine the status of an inbound package 204 contained within the master package. Optionally, any such communications can include a hyperlink to the package administration system website for convenience in accessing the tracking data associated with a package.

By providing the sender 202 and/or recipient 302 with the tracking identifier 231 of the master package 234, which contains their respective package 204, the sender and/or recipient can view the status of their package as it is shipped within the corresponding master package via an external carrier 260. In other words, the sender and/or recipient can view the status of their respective package by accessing the package administration system's website, and entering the tracking identifier 231. In response to receiving the tracking identifier 231, the package administration system 14 retrieves the tracking data associated with the corresponding master package, and transmits the tracking data to the requesting sender's and/or recipient's computer via the network 12.

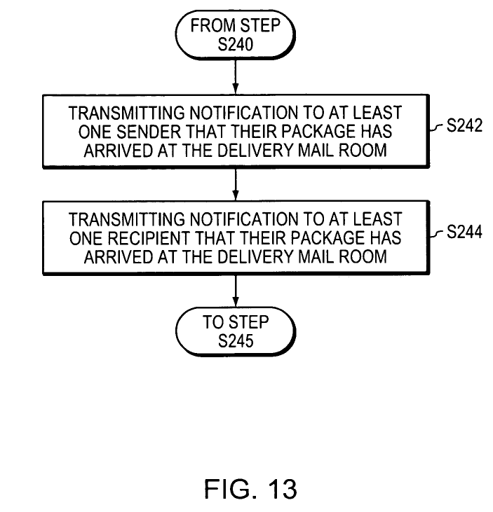

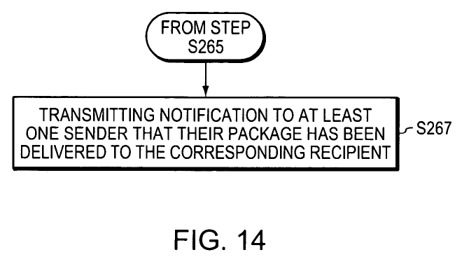

Communications such as email notifications can also be used to inform senders 202, recipients 302, and/or other interested persons of events that occur from the time a master package 324 arrives at a delivery location 300. FIG. 13 shows a process comprising step S242 wherein a notification, such as email, is transmitted to at least one sender 202 informing them that their package 204 has arrived at the delivery mail room 320. Similarly, at step S244, a notification, such as email, is transmitted to at least one recipient 302 informing them that their package 204 has arrived at the delivery mail room 320. FIG. 14 shows yet another possible notification step, wherein at step S267, a communication such as an email is transmitted to at least one sender 202 informing them that their package 204 has been delivered to the corresponding recipient 302.

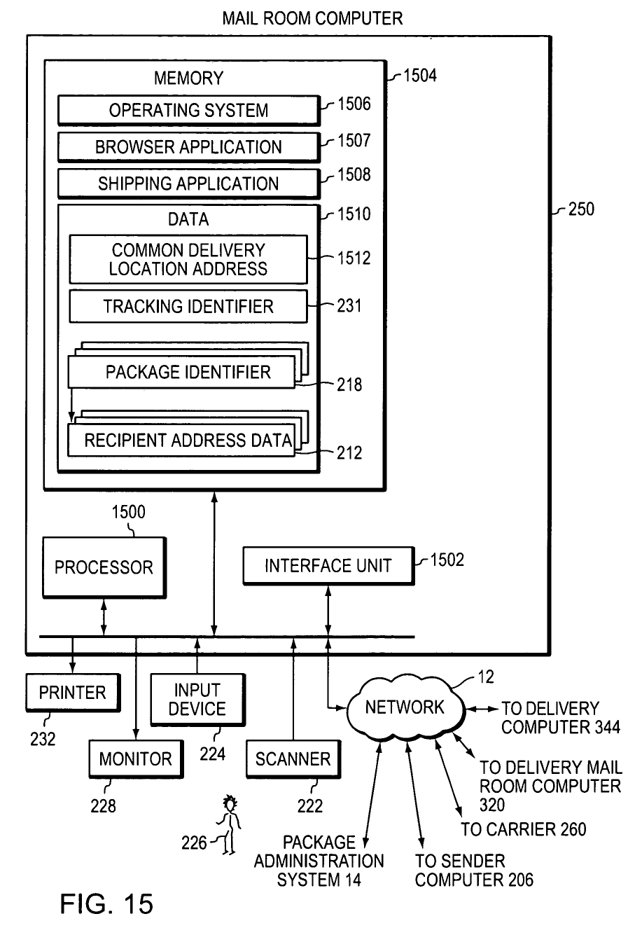

FIG. 15 depicts an embodiment of the invention wherein a sender mail room computer 250 is used to sort packages 204 bound for a common destination 300. The sorting of packages 204 can assist a mail room attendant 226 in aggregating packages bound for a common delivery location 300 so that such packages can be shipped in a consolidated master package 234. Sender mail room computer 250 includes a processor 1500, an interface unit 1502, and memory 1504. The interface unit 1502 is used by the computer 250 to send and receive data over a network 12. The memory 1504 includes: an operating system 1506 executed by the processor 1500 for controlling the allocation and usage of hardware resources; a browser application 1507 for accessing a package administration system 14 to be used in sorting packages 204; optionally, a client-side shipping application 1508 that can be used for sorting packages 204; and a data storage area 1510. Data storage area 1510 can include common delivery location addresses 1512, tracking identifiers 231, package identifiers 218, and recipient address data 212.

A mail room attendant 226 enters package identifiers 218 into the computer 250. The package identifiers can be entered using a scanner 222 or an input device 224 coupled to communicate with the computer 250, for example. The scanner can be optical or electromagnetic, and the input device can be a keyboard, keypad, or other device. The mail room attendant can operate the computer 250 using input device 224, the monitor 228, and the browser application 1507, causing it to transmit the package identifiers 218 from the computer 250 to the package administration system 14 over a network 12. In one embodiment, the package administration system 14 can be configured to retrieve recipient address data 212 from a database 16 corresponding to the received package identifiers 218, and sort the respective packages 204 according to common destinations using the retrieved recipient address data. The results of the sort process can be transmitted from the package administration system 14 to the computer 250, and displayed to the attendant 226 on the monitor 228 using the browser 1507. In another embodiment of the present invention, the computer 250 could be configured with a client-side shipping application 1508 operable to: retrieve recipient address data 212 from the package administration system 14 corresponding to the package identifiers 218 for packages to be shipped; compare the recipient address data for respective package identifiers to determine packages having a common delivery location; and, sort the recipient address data for packages having a common delivery location. The results of the sort process can be displayed to the attendant 226 on the monitor 228 using the browser 1507.

The mail room attendant 226 or other user can use the sort results to select packages 204 bound for a common delivery mail room 320 for inclusion in a master package 234. The mail room attendant 226 can operate the computer 250 to generate a request for a shipping label 230 with a tracking identifier 231, optionally including in the request the package identifiers 218 of the packages 204 to be included in the master package 234. The computer 250 transmits this request to the package administration system 14, which generates and optionally stores the tracking identifier 231 in association with the package identifiers 218. The package administration system 14 transmits the shipping label 230 with tracking identifier 231 to the computer 250 via the network 12. The attendant 226 can print the shipping label 230 with tracking identifier 231 onto media using the printer 232, apply the shipping label to the master package 234, and ship the package with the shipping label to the delivery mail room 320.

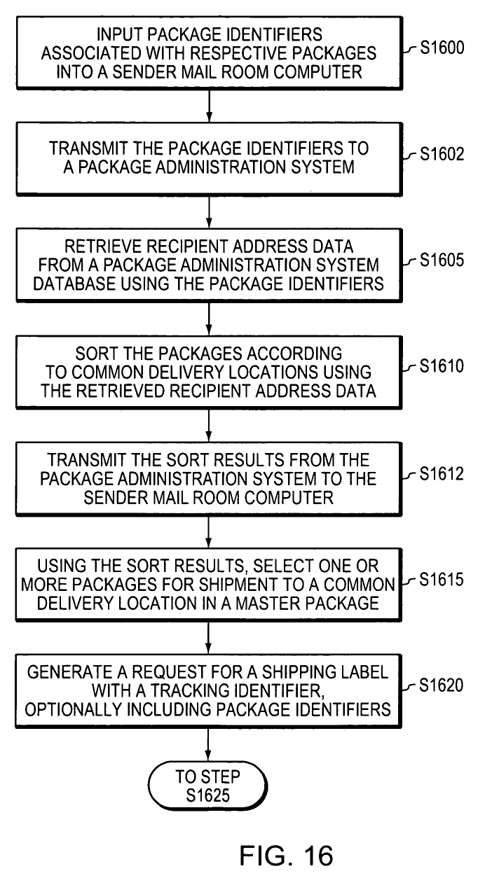

FIG. 16 shows a process for sorting packages 204 based on a common delivery location according to one embodiment of the present invention. This process can be carried out by an attendant 226 using a computer 250, or can be fully automated without requiring human intervention. At step S1600, package identifiers 218 associated with respective packages 204 are input to a computer 250. At step S1602, the package identifiers 204 are transmitted from the computer 250 to a package administration system 14. At step S1605, recipient address data 212 associated with each of the package identifiers 218 is retrieved from a package administration system database 16. At step S1610, the packages 204 are sorted according to common delivery locations using the retrieved recipient address data 212. At step S1612, the results of the sort process are transmitted from the package administration system 14 to the computer 250. At step S1615, the sort results are used to select one or more packages for shipment to a common delivery location 300 in a master package 324. In step S1620 the attendant 226 and/or computer 250 generates a request for a shipping label 230 with a tracking identifier 231. The request can include the package identifiers 218 for the packages to be included in the master package 324.

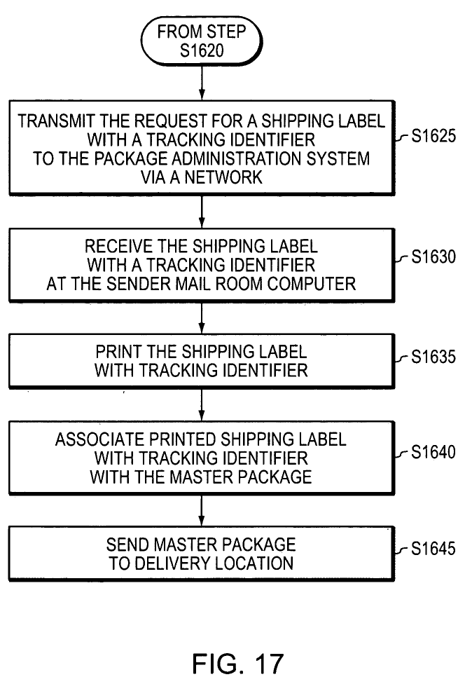

Turning now to FIG. 17, the process continues at step S1625, wherein the request for the shipping label 230 with tracking identifier 231 is transmitted to the package administration system 14 via the network 12. The package administration system 14 receives the request and optional package identifiers 218, generates a shipping label 230 including a tracking identifier 231, optionally stores the package identifiers 218 in association with the tracking identifier 231, and transmits the shipping label with tracking identifier 231 to the computer 250. The computer 250 receives the shipping label 230 with tracking identifier 231 in step S1630, and prints the shipping label with tracking identifier 231 onto print media 233 in step S1635. In Step S1640, the attendant 226 associates the printed shipping label 230 with the master package 234. The attendant 226 sends the master package 234 to the delivery location 320 in step S1645.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

1. A method providing the ability to track intra-organizational mail, comprising:
receiving packages with respective package identifiers at a sender mail room;
aggregating packages that have a common delivery location so that said packages can be shipped to said delivery location in a consolidated master package;
scanning the package identifiers of the packages being placed into the master package using a sender mail room computer;
transmitting scanned package identifiers of the packages contained within said master package from the sender mail room computer to a package administration system;
receiving a tracking identifier from the package administration system for said master package at the sender mail room computer;
associating the tracking identifier with said master package; and
shipping said master package with the associated tracking identifier to said delivery location.

2. A method as claimed in claim 1, wherein said aggregating step comprises:
scanning the package identifiers using a scanning device capable of communicating with a sender mail room computer terminal;
retrieving corresponding recipient address data from a package administration system database using the scanned package identifiers; and
sorting packages based on a common delivery location using the retrieved recipient address data.

3. A method as claimed in claim 1, further comprising:
weighing the consolidated master package to generate weight data using the sender mail room computer; and
transmitting the weight data to the package administration system for use in billing the organization for shipment of the master package from the sender mail room to the delivery location.

4. A method comprising:
retrieving recipient address data for respective packages;
determining packages that have a common delivery location based on corresponding retrieved recipient address data;
aggregating the packages that have the common delivery location so that said packages can be shipped to said delivery location in a consolidated master package;
scanning the package identifiers of the packages being placed into the consolidated master package using a sender mail room computer;
transmitting scanned package identifiers of all packages contained within said master package from the sender mail room computer to the package administration system;
receiving a tracking identifier from the package administration system for said master package at the sender mail room computer;
associating the tracking identifier with said master package; and
shipping said master package with the associated tracking identifier to said delivery location.

5. A method as claimed in claim 4, further comprising:
weighing the consolidated master package to generate weight data using the sender mail room computer; and
transmitting the weight data to the package administration system for use in billing the organization for shipment of the master package from the sender mail room to the delivery location.

6. A method as claimed in claim 4, further comprising:
transmitting the tracking identifier to a sender computer terminal for use in tracking shipment of at least one of the packages in the master package in transit from the sender mail room to the delivery mail room location.

7. A method of providing the capability to track intra-organizational mail, comprising:
receiving recipient address data for shipping addresses of respective packages at a package administration system from corresponding sender computer terminals;
generating package identifiers for the packages using the package administration system;
storing the recipient address data in association with respective package identifiers in the package administration system database;
transmitting the package identifiers from the package administration system to the corresponding sender computer terminals;
receiving package identifiers for a plurality of aggregated packages having a common delivery location at the package administration system;
generating a tracking identifier for a master package used to contain the plurality of packages;
storing the package identifiers in association with the tracking identifier in the package administration system database; and
transmitting the tracking identifier from the package administration system to the sender mail room computer terminal.

8. A method as claimed in claim 7, further comprising:
generating departure tracking data including approximate time of departure of the master package from the sender mail room; and
recording the departure tracking data in association with the tracking identifier;

9. A method as claimed in claim 7, further comprising:
receiving arrival tracking data for said master package at the package administration system from a delivery mail room computer terminal;
associating the arrival tracking data with said tracking identifier and respective package identifiers; and
storing the arrival tracking data associated with the tracking identifier and respective package identifiers in the package administration system database.

10. A method as claimed in claim 7, further comprising:
transmitting the tracking identifier to at least one sender computer terminal to notify respective senders for use in accessing the package administration system to determine the status of the package.

11. A method as claimed in claim 7, further comprising:
transmitting the tracking identifier to at least one recipient computer terminal to notify the respective recipient for use in accessing the package administration system to determine the status of the package.

12. A method as claimed in claim 7, further comprising:
receiving weight data for the master package including the plurality of packages; and
charging the organization for shipment of the master package from the sender mail room to the delivery mail room based on the weight data.

13. A method comprising:
storing package identifiers of a plurality of packages destined for a common delivery location internal to an organization, in association with a tracking identifier identifying a master package containing the packages.

14. A method as claimed in claim 13, further comprising:
storing tracking data in association with the tracking identifier indicating the status of the master package in transport from a sender mail room to the common delivery location.

15. A method as claimed in claim 13, further comprising:
storing weight data in association with the tracking identifier for use in charging the organization for shipment of the master package from a sender mail room to a recipient mail room.

16. A method comprising:
receiving package identifiers for a plurality of aggregated packages having a common delivery location;
generating a tracking identifier for a master package used to contain the packages; and
storing the package identifiers in association with the tracking identifier in a package administration system database.

17. A method providing the capability to track intra-organizational mail, comprising:
receiving a master package at a delivery mail room location, said master package containing a plurality of packages with respective package identifiers that have been aggregated for shipment from a sender mail room to said delivery mail room location;
scanning the tracking identifier on the master package to capture arrival tracking data;
removing the plurality of packages contained within the master package;
scanning the package identifiers on the packages to capture additional arrival tracking data;
transmitting the arrival tracking data associated with the master package and the corresponding plurality of packages from a delivery mail room computer terminal to a package administration system;
delivering the packages to respective recipients;
generating delivery tracking data indicating the approximate times of arrival of the packages at the recipient's locations; and
transmitting the delivery tracking data to the package administration system.

18. A system providing the capability to track packages through interaction with a package administration system, comprising:
a computer terminal capable of communicating with a package administration system;
a scanning device operatively coupled to communicate with the computer terminal, and capable of scanning package identifiers associated with respective packages and communicating said package identifiers to the computer terminal;
the computer terminal executing a browser application operable to retrieve recipient address data corresponding to the package identifiers, the browser application operable by the user to retrieve a tracking identifier from the package administration system and associate the tracking identifier with the scanned package identifiers for the packages having a common delivery location to be contained within a master package; and
a printer for printing a shipping label with the tracking identifier provided by the package administration system for association with the master package.

19. An apparatus communicating with a remote package administration system over a communications network, the apparatus comprising:
a computer terminal executing a shipping application operable to retrieve recipient address data corresponding to package identifiers for packages to be shipped, the computer terminal comparing the recipient address data for respective package identifiers to determine packages having a common delivery location, the computer terminal sorting the recipient address data for packages having a common delivery location, and generating a request to the remote package administration system for a tracking identifier for association with a master package containing packages destined for the common delivery location.

20. An apparatus as claimed in claim 19, wherein the computer terminal transmits the package identifiers for the packages associated with the master package to the remote package administration system to enable individual packages within the master package to be tracked.

21. A container for use in tracking mail, comprising:
a master package capable of containing a plurality of packages destined for the same delivery location, said packages having respective package identifiers associated therewith; and
a tracking identifier associated with the master package.

22. A package administration system comprising:
a server capable of communicating with at least one client running a shipping application; and
a data storage unit having a database for storing package identifiers of a plurality of packages destined for a common delivery location, in association with a tracking identifier identifying a master package containing said packages.

23. An apparatus comprising:
a data storage unit storing
at least one package identifier identifying a package; and
a tracking identifier associated with the package identifier, the tracking identifier identifying a master package for containing the package.

24. An apparatus as claimed in claim 23, further comprising:
account data associated with the package identifier.

25. An apparatus as claimed in claim 23, further comprising:
intra-organizational tracking data associated with the package identifier.

26. An apparatus as claimed in claim 23, further comprising:
tracking data associated with the tracking identifier associated with the package identifier.
